(19) United States
(12) Patent Application Publication
(10) Pub. No.: US 2002/0120780 A1
(43) Pub. Date: Aug. 29, 2002

(54) Two-staged mapping for application specific markup and binary encoding

(75) Inventors: Hawley K. Rising III, San Jose, CA (US); Ali Tabatabai, Beaverton, OR (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sony Corporation, Woodcliff Lake, NJ (US)

(21) Appl. No.: 09/904,271

(22) Filed: Jul. 11, 2001

Related U.S. Application Data
(60) Provisional application No. 60/217,530, filed on Jul. 11, 2000.

(51) Int. Cl. G06F 15/16

(52) U.S. Cl. 709/246

(57) ABSTRACT

In communication system, a method of optimizing MPEG-7 transmissions between a server and an one or more clients, a first ADL (application descriptive language) which is a subset of MPEG-7 DDL (Description definition language) being translated into binary for communication to the first client, the method comprising: receiving, by the first client, the binary communication of the ADL; and translating, by the first client, the binary communication into the first ADL, the binary communication being translated using a frequency table, and an XSLT (XML style translation) document for translating MPEG-7 into the first ADL.

### CROSS-REFERENCES TO RELATED APPLICATION

This application claims priority from co-pending U.S. Provisional Patent Application No. 60/217,530 filed Jul. 11, 2000 entitled A TWO-STAGED MAPPING FOR APPLICATION SPECIFIC MARKUP AND BINARY ENCODING which is hereby incorporated by reference, as is set forth in full in this document, for all purposes.

### COPYRIGHT NOTICE

A portion of the disclosure of this patent document contains material which is subject to copyright protection. The copyright owner has no objection to the xerographic reproduction by anyone of the patent document or the patent disclosure in exactly the form it appears in the Patent and Trademark Office patent file or records, but otherwise reserves all copyright rights whatsoever.

### BACKGROUND

The present invention relates to audio visual information systems, and more specifically to a system for describing, classifying, and retrieving audiovisual information.

The amount of multimedia content available on the World Wide Web and in numerous other databases is growing out of control. However, the enthusiasm for developing multimedia content has led to increasing difficulties in managing accessing and identifying and such content mostly due to their volume. Further more, complexity and a lack of adequate indexing standards are problematic. To address this problem, MPEG-7 is being developed by the Moving Pictures Expert Group (MPEG), which is a working group of ISO/IEC.

In contrast to preceding MPEG standards such as MPEG-1 and MPEG-2 which relate to coded representation of audio-visual content, MPEG-7 is directed to representing information relating to content, and not the content itself. The MPEG-7 standard, formally called the “Multimedia Content Description Interface” seeks to provide a rich set of standardized tools for describing multimedia content. It is the objective to provide a single standard for providing interoperable, simple and flexible solutions to the aforementioned problems vis-a-vis indexing, searching and retrieving multimedia content. It is anticipated that software and hardware systems for efficiently generating and interpreting MPEG-7 descriptions will be developed.

More specifically, MPEG-7 defines and standardizes the following: (1) a core set of Descriptors (Ds) for describing the various features of multimedia content; (2) Description Schemes (DSs) which are pre-defined structures of Descriptors and their relationships; and (3) a Description Definition Language (DDL) for defining Description Schemes and Descriptors.

A Descriptor (D) defines both the semantics and the syntax for representing a particular feature of audiovisual content. A feature is a distinctive characteristic of the data which is of significance to a user.

As noted, DSs are pre-defined structures of Descriptors and their relationships. Specifically, the DS sets forth the structure and semantics of the relationships between its components having either Descriptors and/or Description Schemes. To describe audiovisual content, a concept known as syntactic structure which specifies the physical and logical structure of audiovisual content is utilized.

The Description Definition Language (DDL) is the language that allows the creation of new Description Schemes and Descriptors. It also allows the extension and modification of existing Description Schemes. The DDL has to be able to express spatial, temporal, structural, and conceptual relationships between the elements of a DS, and between DSsn

In line with MPEG spirit, generic MDS (multimedia description schemes) and audiovisual descriptors provide an extensive set of DDL based Ds and DSs markups as tools to create a variety of customized applications. For example, there are descriptors for being able to retrieve images and video by color, tools for decomposing video into scenes and shots, and tools for giving semantic explanations. These tools may be used by a genre marker for a handheld MP3 device, to a complete storyline, a sort of “new age libretto” for an avant-garde film, to be viewed on a very sophisticated editing and mixing device at a professional film studio. Due to the existence of clients with different device capabilities, new markup languages that are optimized toward certain specific applications may become necessary. A case in point is the approach taken by WAP (Wireless Application Protocol) Forum in their design of WML (Wireless Markup Language). WML is a subset of XML, optimized for the unique constraints of the wireless environment; namely: screen size, low resolution, low CPU power, small memory, high latency and intermittent coverage. In addition, given the low transmission bandwidth, WAP utilizes binary transmission to achieve greater compression of data.

Among other disadvantages, convention systems related to MPEG standardization are not extensible. Since these conventional systems rely on a separate standardization process for each domain, or rely on using the same codes and language subsets for all domains, any one or more of the following problems may be encountered: (1) the new application domain may wait a year or two until a new standardized method is ready; (2) the new application will be forced to use a standard optimized for the whole body of tools, resulting in inefficient transmission; and (3) the standard will be unnecessarily limited by the needs of small application domains, and so not implement advanced features.

Therefore there is a need to resolve the aforementioned disadvantages and the present invention meets this need.

### SUMMARY OF THE INVENTION

A first aspect of the present invention provides the necessary tools for creating the proper MPEG-7 DDL, and for creating suitably compact application specific binary code A system for standardizing the development of application specific MPEG-7 DDL derivatives, and a standard way to publish them.

According to an alternate aspect of the present invention, in communication system, a method of optimizing MPEG-7 transmissions between a server and an one or more clients, a first ADL (application descriptive language) which is a subset of MPEG-7 DDL (Description definition language) being translated into binary for communication to the first client. The method comprises: (1) receiving, by the first client, the binary communication of the ADL; and (2) translating, by the first client, the binary communication into the first ADL, the binary communication being translated using a frequency table, and an XSLT (XML style translation) document for translating MPEG-7 into the first ADL.

According to another aspect of the present invention, the method further comprises generating the first ADL from the MPEG-7 DDL.

According to another aspect of the present invention, the method further comprises generating, by the server, the XSLT document.

According to another aspect of the present invention, the method further comprises generating, by the server, the frequency table for translating the first ADL into binary.

According to another aspect of the present invention, the method further comprises downloading, by the first client, the frequency table and the XSLT, prior to receiving the binary communication.

According to another aspect of the present invention, translating the binary document into the first ADL further comprises generating, a decoding code book for the binary communication using the frequency tables and the XSLT document.

According to another aspect of the present invention, the method further comprises communicating information carried by the binary communication to a second client via the server.

According to another aspect of the present invention, the method further comprises translating the first ADL into the binary communication; forwarding the binary communication to the server; translating, by the server, the binary communication into first ADL; translating the first ADL into the MPEG-7 DDL; and translating the MPEG-7 into a second ADL different from the first ADL.

According to another aspect of the present invention, the method further comprises translating the second ADL into binary communication for forwarding to the second client.

Advantageously, the aspects of the present invention provide a standard way to generate efficient binary streams from these derivatives, and a way to publish these as well. The result is a standard for optimizing MPEG-7 transmission over diverse application domains with different bandwidth and descriptive needs.

### BRIEF DESCRIPTION OF THE DRAWINGS

FIG. 1 is a communication network for standardization of MPEG-7 among different domains and for optimizing MPEG-7 transmissions between the domains.

FIG. 2 are exemplary steps of a method for standardization of MPEG-7 among different domains and for optimizing MPEG-7 transmissions between the domains in accordance with a first aspect of the present invention.

### DETAILED DESCRIPTION OF THE INVENTION

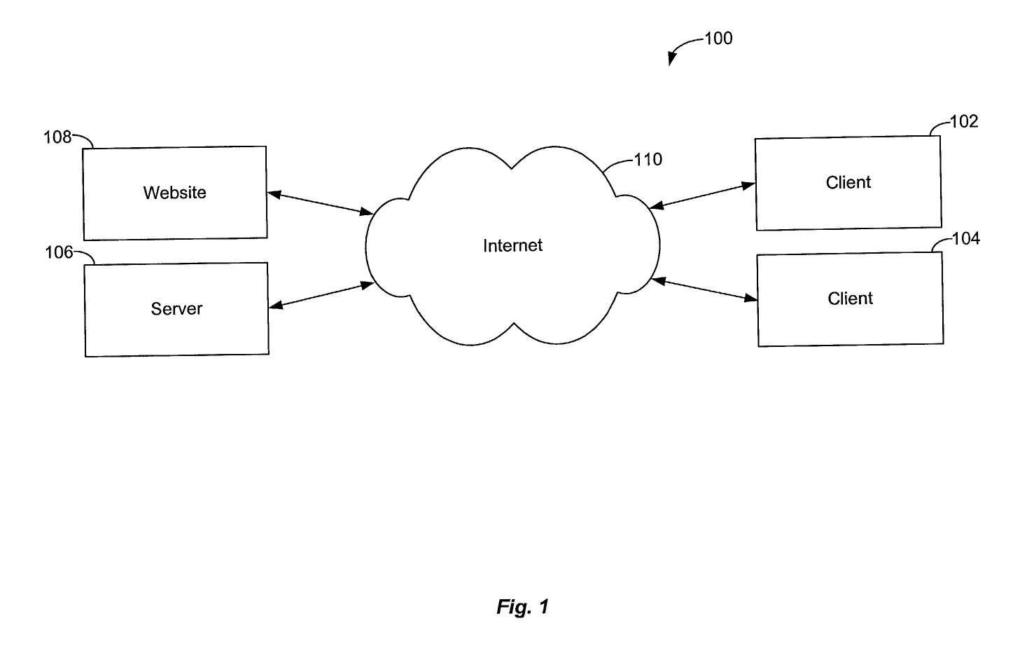

FIG. 1 is a communication network 100 for standardization of MPEG-7 among different domains and for optimizing MPEG-7 transmissions between the domains.

Among other components, communication network 100 comprises a provider or server 102 for the application domain entity (organization or company) which provides an application specific markup language; clients 102, 104 are users of the application domain; public well known address such as a web site 108 which may or may not be served-up by server 106, web site 108 for publishing XSLT (XML Style translation document) for mapping into the application specific language, and for publishing the frequency tables for the D's and DS's in the application specific language; and a communication network 110 such as the Internet.

In use, server 106 generates a list of application specific requirements. Server 106 may be provided by any individuals or organizations that have an interest in creating the domain, or informally by an individual with a website or anything in between. As used herein, the term application specific is used here in a wider sense: It implies bundling a group of applications together, having similar or close characteristics. This is along the same line of practice as it is traditionally done in MPEG when defining profiles. Examples of such requirements are small specialized hardware like stockreading consumer electronic devices, professional editing equipment that needs very big descriptions, computer game devices that need only simplified game scenarios sent, mobile devices with low bandwidth.

As a result of this profiling the creation of new markup languages, called henceforth ADLs (Application Description Languages) become necessary. ADL is a subset of MPEG-7's DDL in that it will contain a limited number of DDL elements. For example, implementing a simple semantic description could require an MPEG-7 compatible decoder to be able to interpret over 75 description schemes. An ADL could be written to drop some of these that weren't used for a purely audio description, resulting in a smaller decoder venue. The codes for binarizing these would need to have frequencies only on the audio elements, so that the ADL binarization would therefore be more efficient. In addition, it may define its own application specific markups and structures for visualization, summary, browsing, scripting etc.

Because different ADLs may exist, transform mechanisms between DDL and ADLs are used. A transform is a mapping of DDL elements to ADL elements. This would include passing the element unchanged, changing it to a broader or narrower term, or dropping it. In addition, some DDL elements might spawn ADL elements that are not in the original description, such as hints on how to display the description to a user. This is equivalent to translating from one DDL vocabulary into another one. XSL (eXtensible Stylesheet Language) is an example of an XML based language designed to transform an XML document into another XML document. XSL is written in XML. ADLs may or may not be written in XML. XSL documents can translate between any text based documents, so XML would be used perhaps usually, but need not if the application required something different.

For each ADL it becomes possible to design a more efficient Text-to-Binary encoding schemes. Essentially this comes about as a result of reoptimizing the binary encoding. All entropy schemes have two parts: The model, which is expressed as frequency tables for the input elements, and the method, which could be Huffman coding (binary tree coding where the tree structure is governed by the frequency table) or Arithmetic coding (fractional coding where the spacing of the choices for the next digit are governed by the frequency table). If the ADL creates a smaller symbol set, by eliminating all DS's and D's and attributes and elements not used by the application, the set of tokens is smaller, so that the entropy coder will generate shorter tokens. Having a limited size of tokens (code symbols for tags, attributes, etc.), is one reason for achieving efficiency.

Because the restrictions are done in the markup language domain, the scheme is extensible, in that it would be possible to design only one binary encoding scheme, say Huffman or arithmetic encoding, and use it for many specialized markups, given the associated frequency tables. This option is included in the syntax below.

The binary encoding can be fully 1 to 1, because any loss of information due to application restrictions will be done in the markup language domain. As in many lossy coding schemes, there is a lossy phase, and a lossless phase. If these are well differentiated, then the lossy phase is done first. Here it is done by pruning the input symbol set. The subsequent entropy phase which is the binary phase, is lossless, hence 1 to 1. An example in a different domain is MPEG 1 or 2, which has a quantization phase in the DCT encoding and motion encoding (which is lossy) followed by Huffman coding which is lossless.

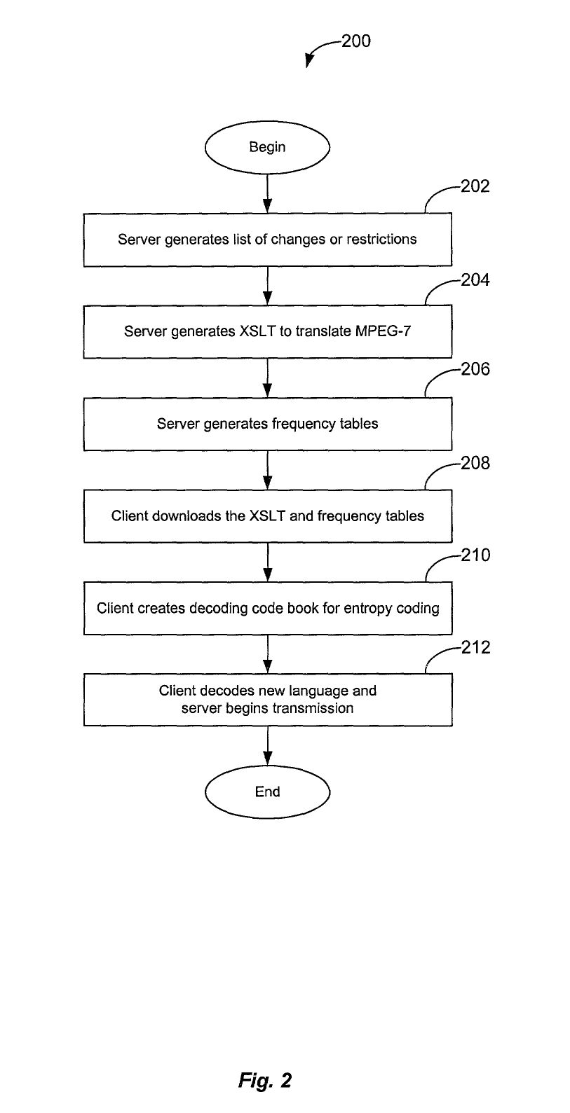

FIG. 2 are exemplary steps of a method for standardization of MPEG-7 among different domains and for optimizing MPEG-7 transmissions between the domains in accordance with a first aspect of the present invention.

At block 202, server 106 generates the list of changes or restrictions to MPEG-7 needed.

At block 204, server 106 generates an XSLT to translate MPEG-7 to the new language.

At block 206, server 106 generates frequency tables used to create the binary. The frequency tables and XSTL document are then provided to web site 108.

At block 208, client 102 downloads the XSLT and frequency tables.

At block 210, client 102 creates the decoding code book for the entropy coding used to transmit, using the frequency tables and the XSLT document.

At block, 212, client 102 can now decode the new language and the providers i.e. server 106 may begin transmission. It should be observed that client 102 from one application domain can access the application domain of client 104 by translating back (via XSLT) to the full DDL, and through a second translation to the other domain. The steps for encoding are DDL→(XSLT)→ADL→(entropy coder)→Binary.

For some application domains the XSLT may be lossless (full descriptions allowed). Likewise, for application domains requiring fixed length codes (such as editing applications) the frequency table to the entropy coder has a uniform distribution. Consequently, many current and alternate schemes are implementable as special cases of this scheme.

### BINARY ENCODING

As mentioned above, the introduction of ADL enables a two-staged approach to the text-to-binary encoding of content descriptions in a more efficient manner. That is, we first transform a DDL based content into an ADL and then use the resulting ADL for text-binary coding. The binary coding is token based. Some tokens are application-specific while others can be global. To facilitate both DDL to ADL translation as well as binary encoding of the resulting DDL, a MarkupTranscodingHints DS with the following syntax is a follows:

<complexType name= “MarkupTranscodingHints”>

<attribute name= “id” type= “ID” use= “required”/>
<attribute name= “href” type= “uriReference” use= “optional’/>
<attribute name= “idref” type= “IDREF”
refType= “transformHints”/>
<element name= “TokenRef” minOccurs= “O” maxOccurs
“unbounded”>

<complexType>

<attribute name= “id” type= “ID” use= “required”/>
<attribute name= “href” type= “uriReference”
use= “optional”/>

| | | |
|---|---|---|
| <attribute | name= “idref” | type= “IDREF” |

refType= “AttributeValuePair”/>

</complexType>

</element>

</ complexType>

The syntax refers to the way the translation entity as well as both local and global token tables for binary encoding. Hints such as frequency tables for Huffman or Q coder can also be included and published across applications. Other general guidelines for the design of a more efficient binary coding scheme are the use a context-based approach, which will enable us to use overlapping code spaces. An example of such an approach is the design of two-state parser with element and attribute as its state. A more compact binary representation is implementable, if the frequency of occurrence of each token is taken into account in the design of (adaptive) Huffman codes.

Advantageously, a first aspect of the present invention discloses Application Description Languages as a way for profiling MPEG-7 tools. These ADLs are designed to take into account the constraints and requirements of the applications they will be serving. Furthermore, a two-stage methodology for the binary encoding of DDL through ADLs. This two-stage approach includes Transform language implementation for translating between DDL and ADLs. The syntax in the TranscodingHints DS should include an attribute (or element) to refer to the transform.

While the above is a complete description of exemplary specific embodiments of the invention, additional embodiments are also possible. Thus, the above description should not be taken as limiting the scope of the invention, which is defined by the appended claims along with their full scope of equivalents.

What is claimed is:

1. In communication system, a method of optimizing MPEG-7 transmissions between a server and an one or more clients, a first ADL (application descriptive language) which is a subset of MPEG-7 DDL (Description definition language) being translated into binary for communication to the first client, the method comprising:
receiving, by the first client, the binary communication of the ADL; and
translating, by the first client, the binary communication into the first ADL, the binary communication being translated using a frequency table, and an XSLT (XML style translation) document for translating MPEG-7 into the first ADL.

2. The method of claim 1 further comprising
generating the first ADL from the MPEG-7 DDL.

3. The method of claim 1 further comprising
generating, by the server, the XSLT document.

4. The method of claim 1 further comprising
generating, by the server, the frequency table for translating the first ADL into binary.

5. The method of claim 1 further comprising
downloading, by the first client, the frequency table and the XSLT, prior to receiving the binary communication.

6. The method of claim 1 wherein translating the binary document into the first ADL further comprises
generating, a decoding codebook for the binary communication using the frequency tables and the XSLT document.

7. The method of claim 1 further comprising
communicating information carried by the binary communication to a second client via the server.

8. The method of claim 7 further comprising
translating the first ADL into the binary communication;
forwarding the binary communication to the server;
translating, by the server, the binary communication into first ADL;
translating the first ADL into the MPEG-7 DDL; and
translating the MPEG-7 into a second ADL different from the first ADL.

9. The system of claim 8 further comprising
translating the second ADL into binary communication for forwarding to the second client.
